(19) United States
(12) Patent Application Publication
(10) Pub. No.: US 2005/0203776 A1
(43) Pub. Date: Sep. 15, 2005

(54) Method of identifying clinical trial participants

(76) Inventors: Sharen A. Godwin, Wilmington, NC (US); J. Tobin Geatz, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 10/800,876

(22) Filed: Mar. 15, 2004

(51) Int. Cl. G06F 17/60

(52) U.S. Cl. 705/3

(57) ABSTRACT

Potential clinical trial participants are identified using a data source that includes dictation records of at least one healthcare professional containing information relating to the medical conditions of a plurality of patients identified by non-personal identifiers, by a method that includes the steps of establishing a search query based on participant criteria for acceptable participants for a given clinical trial; selecting non-personal identifiers of patients meeting the search query; transmitting identifiers of selected patients to the healthcare professional for use in contacting the selected patients to be determine their interest in participating in the clinical study, and to receive the patients' authorization to be contacted by the researcher or a research management organization acting on behalf of the researcher. Preferably, the data source is a data stream generated during transcription of records dictated by healthcare professionals, but not excluding billing, admission/discharge, laboratory, or prescription data streams with each patient record being compared against the search criteria immediately following transcription.

### BACKGROUND OF THE INVENTION

(1) Field of the Invention

The present invention relates to a method for selecting clinical trial participants based on a comparison of predetermined criteria with information in healthcare professional originated records, and in particular to a method of selecting clinical trial participants using healthcare professional originated records without violating the privacy rights of patients. The invention also relates to a method of ascertaining the other relevant information in clinical trial participant selection, including the geographic locale of prospective clinical trial participants meeting predetermined criteria, identification of clinical trial participant clusters, identification of clinical trial potential physician clusters and potential study sites.

(2) Description of the Prior Art

Clinical trials are research studies conducted using human volunteers to answer specific health questions. These trials may be used, for example, to test new drugs, treatments, or new approaches to surgery or radiation therapy; to study new ways to prevent a disease or to prevent a disease from returning; to evaluate procedures for detecting or diagnosing a particular disease or condition; to test or improve drug devices; or to find ways to improve the comfort and quality of life for individuals with a chronic illness. Clinical trials are conducted by researchers who are employed by or sponsored by pharmaceutical companies, universities, medical institutions, foundations, governmental agencies, etc.

Participants in a given clinical trial must meet participant criteria established by the clinical trial researcher, the term being used herein to encompass an individual researcher or a plurality of individuals working together on the particular trial, e.g., a group including physicians, nurses, research scientists, and/or other healthcare, research or academic professionals. These criteria may comprise inclusion criteria that must be present and/or exclusion criteria that must not be present. Such criteria may include the type and stage of the disease, previous treatment history, other medical conditions, and factors such as age and gender. Whether or not a given factor is inclusive or exclusive depends on the nature of the trial to be undertaken.

Potential participants are carefully advised of the details of the trial as it may affect them individually to ensure that any decision to participate is made with informed consent. These details include the potentially positive aspects of the study as well as possible negative aspects. A participant may withdraw from a clinical trial at any time.

Individuals are motivated to participate in clinical trials for various reasons. The individual may use the trial as an opportunity to gain access to new drugs or treatments, or to obtain medical care from healthcare professionals or medical facilities that would not normally be affordable or available. The individual may have an altruistic desire to contribute to medical research that would benefit others. At the other extreme, the individual may desire to participate for monetary remuneration.

Various techniques are currently used to identify suitable participants. The researcher or an entity acting for the researcher may place advertisements in various outreach media, e.g., newspapers, radio, television, or other media likely to be seen or read by potential participants. Websites may be created to contact Internet users. Informational materials may be disseminated to support groups for a given disease. Response rates are usually low due to lack of interest or awareness, and the individuals who do respond are often unqualified, resulting in a high screening cost per qualified participant.

Physicians and other healthcare professionals who have patients meeting the participant criteria also provide participant leads. Referral rates from healthcare professionals are less than optimal, however, due to various factors. Healthcare professionals are usually extremely busy with their professional activities, leaving little time to study available patient information in order to identify potential trial participants. Delegation to support personnel is often ineffective due to other priorities and limited capability of personnel to accurately analyze the information. Data mining resources are also limited due to the need to preserve patient privacy, and to comply with relevant laws and regulations, such as HIPAA (Health Insurance Portability and Accountability Act).

Potential participant identification is also rendered difficult and time consuming due to the multiple forms of records and its manual nature that must be kept as part of a healthcare practice.

In reality, the majority of possible trial participants are provided by a relatively few and generally repeat healthcare professionals who believe that the payment per participant received justifies the time and effort, or who wish to promote clinical trials for other reasons. As a result, patients in a given clinical trial may be clustered within a geographical area or by their relationship to one healthcare professional. Lack of healthcare professional participation also inhibits the identification of geographic areas having a high incidence, or low incidence, of a given medical condition. Indicative of this dilemma is the number of repeat study sites and patients for multiple studies, identified by the FDA as a potential gap for review consideration.

Therefore, there is a need for a method of easily identifying qualified potential clinical trial participants from a large group of potential patients, without violating patients' rights of privacy or other legal or regulatory rights. There is a further need for a method of acquiring other related clinical trial participant information, such as geographical locations, health characteristics, lifestyle information, patient clusters, physician clusters, and study site data.

### SUMMARY OF THE INVENTION

Generally, the present invention relates to a method of identifying prospective clinical trial participants meeting predetermined criteria using a database or other data source that includes records originated by at least one healthcare professional containing information relating to the medical conditions of a plurality of patients identified by non-personal identifiers, comprising receiving predetermined criteria from a clinical researcher; selecting patients from the data source that potentially meet the criteria; and transmitting identifiers of selected patients to the healthcare professional to enable the healthcare professional to obtain the authorization of selected patients and advise a research entity of selected patients who provided authorization. The research entity, or healthcare provider acting on behalf of the research entity, then contacts authorizing patients to further explore the qualifications of the patients, to advise them of information required for informed consent, and to sign up qualified, interested participants. As used herein, the term “research entity” is intended to include both clinical researchers and any entity acting on behalf of the clinical researcher in identifying and recruiting participants, defined herein as a research management organization (RMO).

The data source includes records originated by one or more healthcare professionals, e.g., physicians, dentists, chiropractors, hospitals, clinics, etc., recorded to summarize patient examinations, e.g., dictation records or records derived from dictation records, billing records, and other records used by the healthcare professional. As used herein, the term “dictation records” means the recorded audio dictation by the healthcare professional and transcriptions of the dictation into a written format, e.g., a document file, while the term “originated records” includes dictation records and records derived from dictation records. Healthcare dictation records tend to be free-form and inclusive, including not only the summarized identification of a patient's medical condition, but also subjective data, objective data, treatment plans, details of the disease state, symptoms, test results, patient concerns and complaints, ICD (International Classification of Diseases) codes, and other factors relevant to the inclusion/exclusion criteria of clinical trials.

Dictation by healthcare professionals is normally transcribed shortly after dictation, either by typing or by using voice-to-text software, but may also be stored as dictated in audio format. Technological advances in database mining permit searching of either form of dictation records, and it is within the scope of the present invention to provide databases containing one or both forms of dictations records. The data source contemplated by the present invention may consist only of dictation records, or may comprise dictation records in combination with other patient information sources, such as billing records, laboratory records, admission records, etc. The database may also include patient demographic information, such as age, gender, geographic locale, etc.

Any use of a data source must comply with the patient privacy requirements of HIPAA and other laws and regulations. For example, non-personal identifiers, such as alphanumeric identifiers, e.g., a patient identification number, are used to identify all patients referred to in the database information. Thus, when the data source is searched, there will be no way for the database technician or other personnel having access to the database to ascertain, or disclose to others, the identity of any patient whose information is in the database. Instead, the patient can only be identified by the healthcare professional providing the patient identifier.

Permanent storage of patient information in a database containing multiple patient records, even using patient identifiers, may present conflicts with HIPAA regulations. Therefore, a unique aspect of the present information is to access the stream of data generated by a channel vendor during transcription of healthcare provider dictation. A channel vendor is an entity that receives patient information. For example, dictation from a healthcare provider would be transcribed, and the transcribed information returned to the healthcare provider for subsequent use, e.g., in the generation of billing records and other records used by the healthcare provider. This services in normally provided shortly after the record is dictated. Unlike a database comprised of multiple stored records, a data stream is comprised of a continuum of individual records as they are transcribed. Thus, in the preferred embodiment, individual patient records are immediately compared against the search criteria during the transcription process. A patient data stream may originate with dictation, transcription, billing, admission/discharge, laboratory, or prescription depending on the channel vendor as defined above.

In accordance with a preferred aspect of the present invention, dictation records provided to the channel vendor are analyzed in accordance with the predetermined criteria. Normally, the transcribed record will be analyzed immediately after it is generated and before it is transmitted to the healthcare provider. However, it will be understood that the invention in a broader sense also contemplates analysis of dictation before transcription. The significant criterion in this aspect of the invention is to analyze the records at the time of transcription, instead of accumulating the records in a database.

The data source is searched for possible participants for a given clinical trial using a search query based on the participant criteria established for the trial. Various qualifiers to improve search results can be included in the query, i.e., date ranges, patient geographical locale, term weighting, synonym inclusion or exclusion, truncated terms, and word proximity. Since dictation records are far more inclusive than other types of medical records, potential participants may be identified that would otherwise be overlooked.

Search reports including information about patients meeting the search criteria are sent to the healthcare professional that initially submitted the patient information. Patient identification may be only an alphanumeric identifier that will enable the healthcare professional to retrieve the patient's records from the healthcare professional's files. Optionally, the search report can include additional information, such as the search query used, and the segments of the patient's records that generated the hit. This additional information will enable the healthcare professional to further evaluate patient qualifications.

The healthcare professional may use the search results, with or without further evaluation, to contact the identified patients to determine if they are interested in participating in the clinical trial. This contact will provide the healthcare professional with the opportunity to describe the clinical trial and its potential benefits and disadvantages to the patient. If sufficiently detailed to constitute the required informed consent, it may be possible based on the discussion for the patient to agree to participate in the trial at that time.

If approved, the patient's name and contact information will be transmitted to a research entity, i.e., the researcher or research management organization acting on behalf of the researcher, who will contact the patient regarding interest and next steps. In most instances, however, the healthcare professional will merely determine if the patient is interested in contacting the research entity to discuss possible participation. The research entity will then conduct a pre-qualified interview process with the patient to determine if the patient is qualified for the particular study and desires to participate.

### BRIEF DESCRIPTION OF THE DRAWINGS

FIG. 1 is a schematic of a first embodiment of the invention.

FIG. 2 is a schematic of a second embodiment of the invention.

FIG. 3 is a schematic of a third embodiment of the invention.

### DETAILED DESCRIPTION OF THE INVENTION

The overall objective of the present invention is to provide a method for identifying potential clinical trial participants who meet the participant criteria of a clinical trial using a data source that includes healthcare professional dictation records, while preserving patient confidentiality. This objective can be accomplished in various ways depending upon the level of involvement of the researcher and the healthcare professionals. The drawings and following description illustrate three methods of achieving this objective. Other methods will be readily apparent to one skilled in the art. While the following examples describe a single healthcare professional, it will also be apparent that multiple healthcare professionals can participate in the methodology.

### EXAMPLE 1

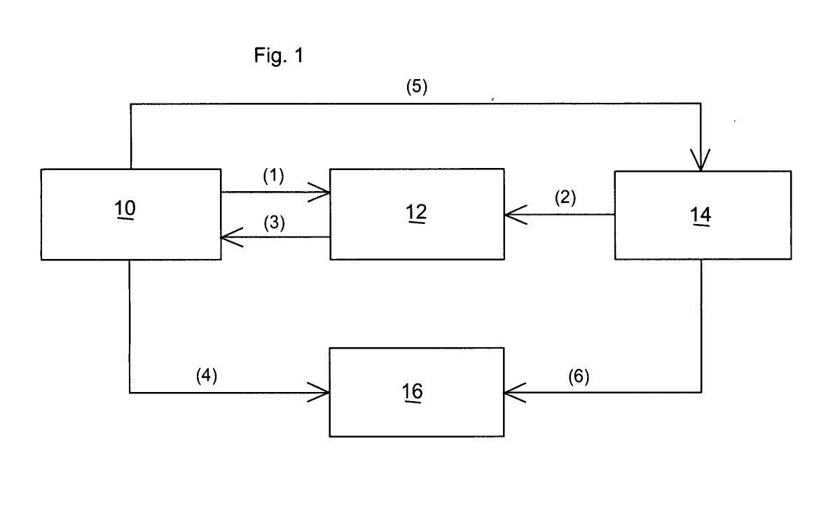

FIG. 1 illustrates a simple embodiment of the invention in which a Healthcare Professional 10 inputs data including dictation records into a data source 12, shown as step (1). Researcher 14 then inputs a search query based on participant criteria for a given clinical trial into data source 12, shown as step (2). The output from a search of the data source records against the search query is then sent to the Healthcare Professional 10, shown as step (3). Healthcare Professional 12, with or without further analysis of the search results, contacts prospective Patients 16 found by the search, shown as step (4). Healthcare Professional 12 then transmits the names and contact information for interested, authorizing Patients 16 to Researcher 14, shown as step (5). Researcher 14 then contacts Patients 16, shown as step (6).

In this example and the following examples, the data sources may be a database containing multiple stored records, or a data stream generated during transcription of dictated records, with each patient record being individually compared against the search criteria immediately upon creation of the transcription and without storage of the record in database. If the data source is a data stream, this analysis is continued over a period of time until sufficient clinical participant data meeting the search criteria is obtained.

### EXAMPLE 2

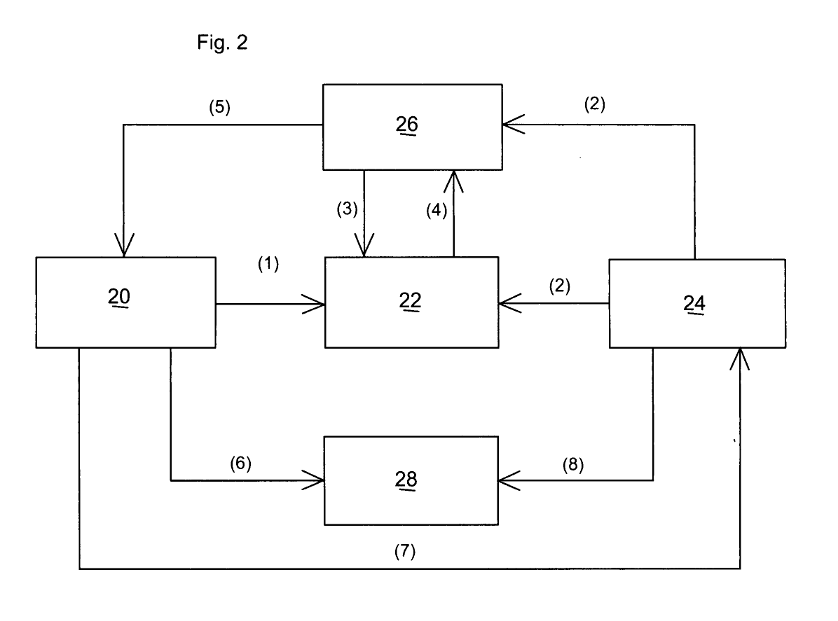

FIG. 2 illustrates a second embodiment of the invention, which includes the participation of a third entity, referred to herein as the Research Management Organization (RMO), who relieves the Healthcare Professional and Researcher of some of the activities required in the selection process.

In this embodiment, Healthcare Professional 20 inputs data including dictation records in audio and/or transcribed form into data source 22, shown as step (1). Researcher 24 provides participant criteria for a given clinical trial to RMO 26, shown as step (2). RMO 26 inputs a search request based on participant criteria into data source 22, shown as step (3), and receives the search results, shown as step (4). RMO 26 then sends the search results to Healthcare Professional 20, shown as step (5). Healthcare professional 20, with or without further analysis of the search results, contacts prospective Patients 28 found by the search, shown as step (6). Healthcare Professional 20 then transmits the names and contact information for interested, authorizing Patients to Researcher 24, shown as step (7). Researcher 14 then contacts Patients 26, shown as step (8).

### EXAMPLE 3

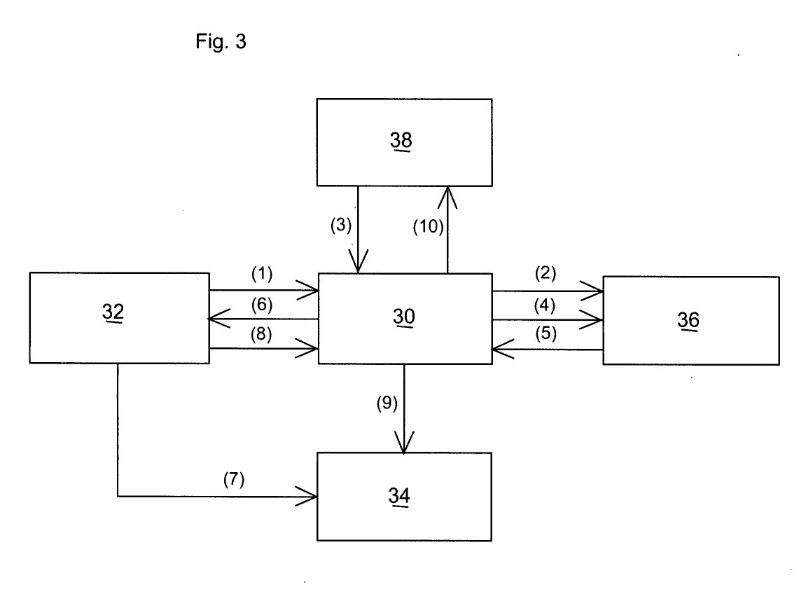

FIG. 3 illustrates a third embodiment of the invention in which RMO 30 performs most of the required activities. Specifically, RMO 30 receives information from one or more Healthcare Professionals 32 relating to the medical condition and characteristics, e.g., age, gender, geographic locale, etc., of a plurality of Patients 34 identified by a non-personal identifiers, such as alphanumeric identifiers, shown as step (1). RMO 30 then inputs the data into a data source 36, shown as step (2).

RMO 30 also receives participant criteria for a given clinical trial from Researcher 38, shown as step (3). RMO 30 inputs a search query based on participant criteria into data source 36, shown as step (4), and receives the search results, shown as step (5). RMO 30 then sends the search results to Healthcare Professional 32, shown as step (6). Healthcare Professional 32, with or without further analysis of the search results, contacts prospective Patients 34 found by the search, shown as step (7). Healthcare Professional 32 then transmits the names and contact information for interested, authorizing Patients 34 to RMO 30, shown as step (8). RMO 14 then contacts authorizing Patients 34, shown as step (9), to arrange for interviews meeting informed consent requirements and to sign up interested patients as clinical trial participants. Finally, RMO 14 transmits the names and contact information of clinical trial participants to Researcher 34, shown as step 10. Thus, by the method of the present invention, it is possible to effectively identify qualified clinical trial participants using patient information including dictation records without violating a patient's right to privacy.

Certain modifications and improvements will occur to those skilled in the art upon a reading of the foregoing description. It should be understood that all such modifications and improvements have been deleted herein for the sake of conciseness and readability but are properly within the scope of the following claims.

1. A method of acquiring information relating to potential clinical trial participants meeting predetermined criteria using a data source that includes the dictation records of at least one healthcare professional containing information relating to the medical conditions of a plurality of patients identified by non-personal identifiers;
a) selecting the identifiers of patients in said data source that potentially meet said criteria; and
b) transmitting said patient identifiers to said healthcare professional to enable said healthcare professional to contact said patients regarding said clinical trial.

2. The method of claim 1, wherein said data source is a data stream generated during transcription of dictated records.

3. The method of claim 1, wherein said dictation records are transcribed dictation records.

4. The method of claim 3, wherein each transcribed dictation record is compared against said criteria immediately following transcription.

5. The method of claim 1, wherein said healthcare professional is selected from the group consisting of physicians, dentists, chiropractors, hospitals and clinics.

6. The method of claim 1, wherein said predetermined criteria include at least one criterion selected from the group consisting of disease state, ICD code, and patient complaint.

7. The method of claim 1, wherein said data source includes at least one additional source of information relating to the medical conditions of said patients selected from the group consisting of billing records, laboratory records, and admission records, and demographic information.

8. A method of identifying prospective clinical trial participants meeting predetermined criteria using a data source including the dictation records of at least one healthcare professional containing information relating to the medical conditions of a plurality of patients identified by non-personal identifiers comprising:
a) receiving predetermined criteria from a clinical researcher;
b) preparing a search query based on said predetermined criteria;
c) selecting non-personal identifiers of patients in said data source that potentially meet said criteria; and
d) transmitting said identifiers to said healthcare professional to enable said healthcare professional to contact patients who would want to consider participating in said trial.

9. The method of claim 8, wherein said data source is a data stream generated during transcription of dictated records.

10. The method of claim 8, wherein said non-personal identifier is an alphanumeric identifier.

11. The method of claim 8, wherein said dictation records are transcribed dictation records.

12. The method of claim 8, wherein said healthcare professional is selected from the group consisting of physicians, dentists, chiropractors, hospitals and clinics.

13. The method of claim 8, wherein said predetermined criteria include at least one criterion selected from the group consisting of disease state, ICD-9 code and patient complaint.

14. The method of claim 8, wherein said database includes at least one additional source of information relating to the medical conditions of said patients selected from the group consisting of billing records, laboratory records, and admission records.

15. The method of claim 8, wherein said database includes the geographical locations of said patients.

16. A method of identifying prospective participants for a clinical trial who meet participant criteria from a data stream of individual patient records created during transcription of the dictation of at least one healthcare professional containing information relating to the medical conditions of a plurality of patients identified by non-personal identifiers comprising:
a) preparing a search query based on said predetermined criteria;
b) comparing each of said records against said query immediately following creation of the record;
c) selecting non-personal identifiers of patients in said data stream that potentially meet said criteria;
d) transmitting said non-personal identifiers of selected patients to said healthcare professional for use by the healthcare professional in obtaining contact authorization from selected patients;
e) receiving the names of patients who have consented to be interview regarding the clinical trial from said healthcare professional; and
f) contacting patients whose names are received from said healthcare professional.

17. The method of claim 16, wherein said query is based on information provided by a clinical researcher, said method further including the step of providing the identification of authorizing patients to said researcher.

18. The method of claim 16, wherein said data stream includes the geographical location of said patients.

19. The method of claim 16, wherein said data stream includes dictation records of a plurality of healthcare professionals, the identifier of each selected patient being transmitted to the healthcare professional originating the record relating to the medical conditions of the selected patient.

20. The method of claim 16, wherein said data stream is accessed after transcription.
